(19) United States
(12) Patent Application Publication
(10) Pub. No.: US 2011/0279687 A1
(43) Pub. Date: Nov. 17, 2011

(54) NOTEBOOK COMPUTER WITH PICO-PROJECTOR AND DIGITAL CAMERA

(75) Inventor: YUNG-LUNG LIU, Ta Ya Shiang (TW)

(73) Assignee: Sunrex Technology Corp., Ta Ya Shiang (TW)

(21) Appl. No.: 12/778,561

(22) Filed: May 12, 2010

(51) Int. Cl. H04N 5/225

(52) U.S. Cl. 348/207.1; 348/E05.024

(57) ABSTRACT

A notebook computer includes a housing comprising a keyboard; an LCD pivotably mounted to a front edge of the housing; an inverted U shaped frame pivotably mounted to the front edge of the housing wherein the frame and the LCD are adapted to rest upon the housing by pivoting; a pivotal pico-projector on the frame; and a pivotal digital camera on the frame. The notebook computer provides more features for use choice.

### BACKGROUND OF THE INVENTION

1. Field of Invention

The invention relates to notebook computers and more particularly to such a notebook computer having both a pico-projector and a digital camera pivotably mounted thereon.

2. Description of Related Art

It is not convenient if there is no projector available in a meeting or briefing when such need arises. Therefore, a type of notebook computer having a pico-projector is commercially available. The pico-projector is pivotably mounted on a top edge of the display of the notebook computer. The pico-projector can operate in cooperation with the notebook computer if there is no projector available in a meeting or briefing when such need arises. It thus brings a lot of convenience.

However, it has the following disadvantages: For example, the pico-projector cannot be operated independently (i.e., both the display and the pico-projector are required to pivot synchronously). Further, the notebook computer may shake when the pico-projector pivots. This inevitably compromises the desired features of the notebook computer. Moreover, LED (light-emitting diode) light source is employed by the pico-projector and this can consume energy and how to effectively dissipate heat is a problem to be solved. In addition, lens and other associated components make the pico-projector bulky, cost ineffective, and being low in projection resolution. Thus, the need for improvement still exists.

### SUMMARY OF THE INVENTION

It is therefore one object of the invention to provide a notebook computer comprising a housing comprising a keyboard; an LCD (liquid crystal display) pivotably mounted to a front edge of the housing; an inverted U shaped frame pivotably mounted to the front edge of the housing wherein the frame and the LCD are adapted to rest upon the housing by pivoting; a pivotal pico-projector on the frame; and a pivotal digital camera on the frame.

In one aspect of the invention the pico-projector comprises an image processing unit, an image memory for storing images from the image processing unit and sending the images to the image processing unit, an imaging unit, a zoom lens drive unit, a laser light source for emitting laser light as instructed by the image processing unit, a zoom lens for projecting laser light from the laser light source as instructed by the zoom lens drive unit, a bus electrically connected to the image processing unit, the imaging unit, and the zoom lens drive unit, and a microprocessor electrically connected to the bus for controlling the image processing unit, the imaging unit, and the zoom lens drive unit.

In another aspect of the invention the digital camera comprises an optical system for taking pictures, an image sensor for sensing pictures taken by the optical system, an ADC (analog to digital converter) for converting analog signals of the taken pictures into digital signals, an image formation unit for transforming the digital signals into images, a ROM (read-only memory) for storing instructions required for operating the digital camera, a work memory for temporarily storing the images from the image formation unit, and a microprocessor electrically connected to the image sensor, the ADC, the image formation unit, the ROM, and the work memory for controlling their operations, the microprocessor being adapted to instruct the work memory to send the stored images to the LCD of the notebook computer for display.

The above and other objects, features and advantages of the invention will become apparent from the following detailed description taken with the accompanying drawings.

### BRIEF DESCRIPTION OF THE DRAWINGS

FIG. 1 is a perspective view of a notebook computer according to the invention;

FIG. 2 is an environmental view of the digital camera being operated to taking a picture of an object;

FIG. 3 is an environmental view of the pico-projector being operated to throw an image on a screen;

FIG. 4 is a side elevation of the notebook computer;

FIG. 5 is a block diagram of the pico-projector; and

FIG. 6 is a block diagram of the digital camera.

### DETAILED DESCRIPTION OF THE INVENTION

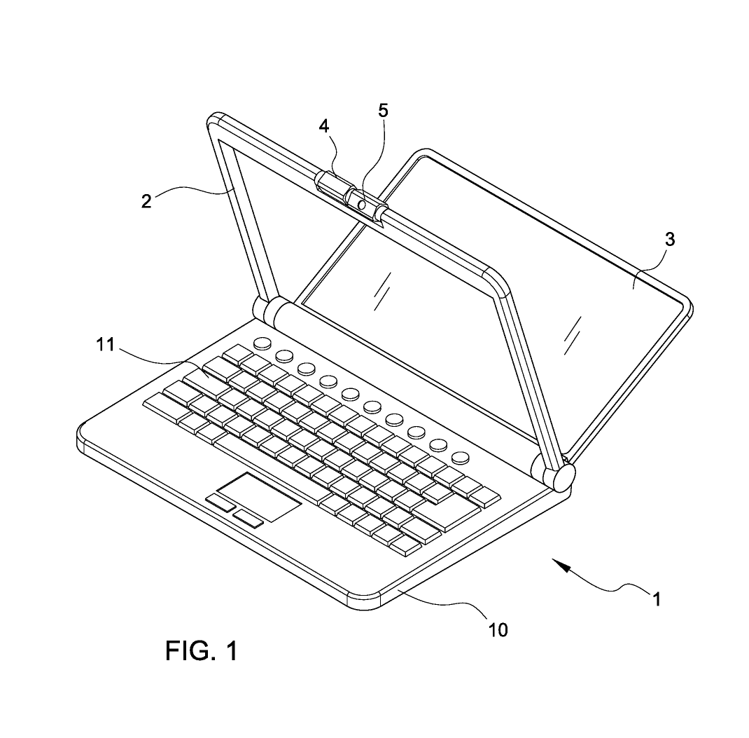

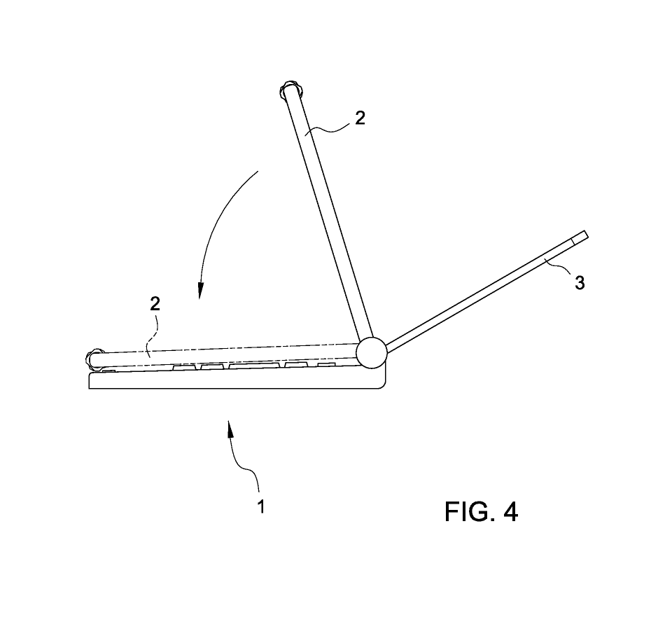

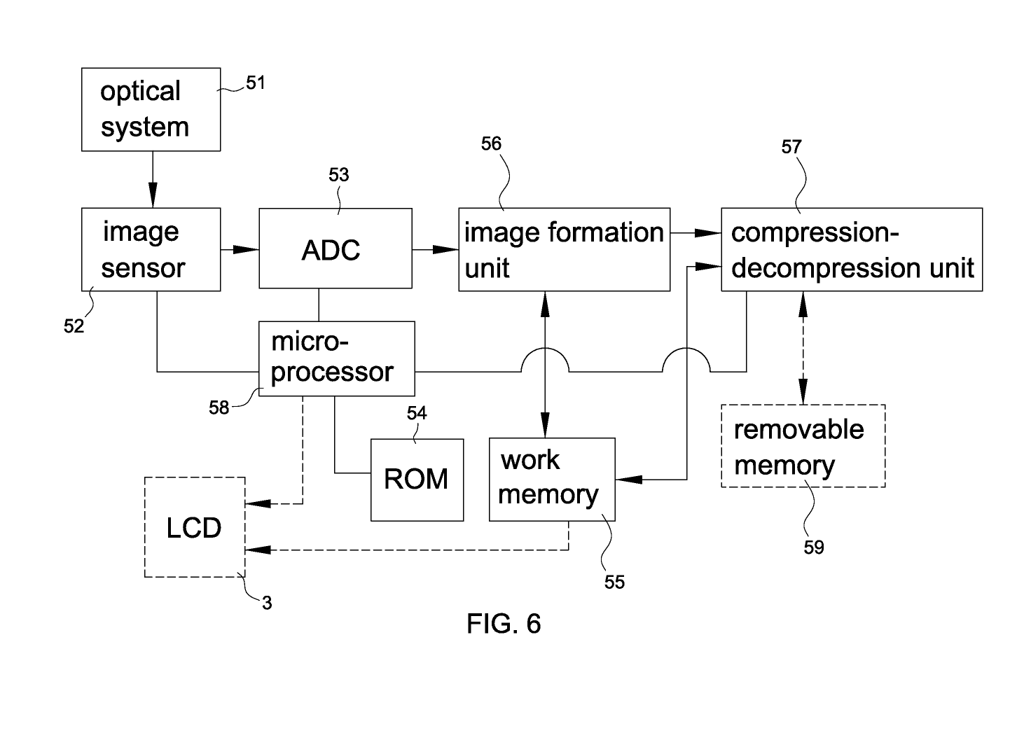

Referring to FIGS. 1 to 6, a notebook computer 1 in accordance with the invention comprises the following components as discussed in detail below.

A rectangular housing 10 has a keyboard 11 mounted thereon. An LCD (liquid crystal display) 3 is pivotably provided to a front edge of the housing 10. An inverted U shaped frame 2 is also pivotably provided to the front edge of the housing 10 but between the housing 10 and the LCD 3. Both the frame 2 and the LCD 3 can be pivoted to rest upon the housing 10 to close the notebook computer 1 as well known in the art. Moreover, the frame 2 can be rested upon a support surface (e.g., desk top) to stably support the notebook computer 1.

A pico-projector 4 has a transverse pivot axis (not shown) having both ends pivotably secured to a horizontal portion of the frame 2 so that the pico-projector 4 is pivotal to adjust its projection angle. The pico-projector 4 is implemented by DLP (digital light processing) technology with embedded LEDs, LCOS (Liquid Crystal on Silicon) technology with embedded LEDs, or laser based technology (in this embodiment).

A digital camera 5 has a transverse pivot axis (not shown) having both ends pivotably secured to a horizontal portion of the frame 2 so that the digital camera 5 is pivotal to adjust its picture taking angle. Moreover, the digital camera 5 is disposed beside the pico-projector 4. Keyboard 11, LCD 3, and other components of the notebook computer 1 such as motherboard, hard disk, etc. are known in the art and are not subject of the invention. Therefore, their description is omitted herein for the sake of brevity.

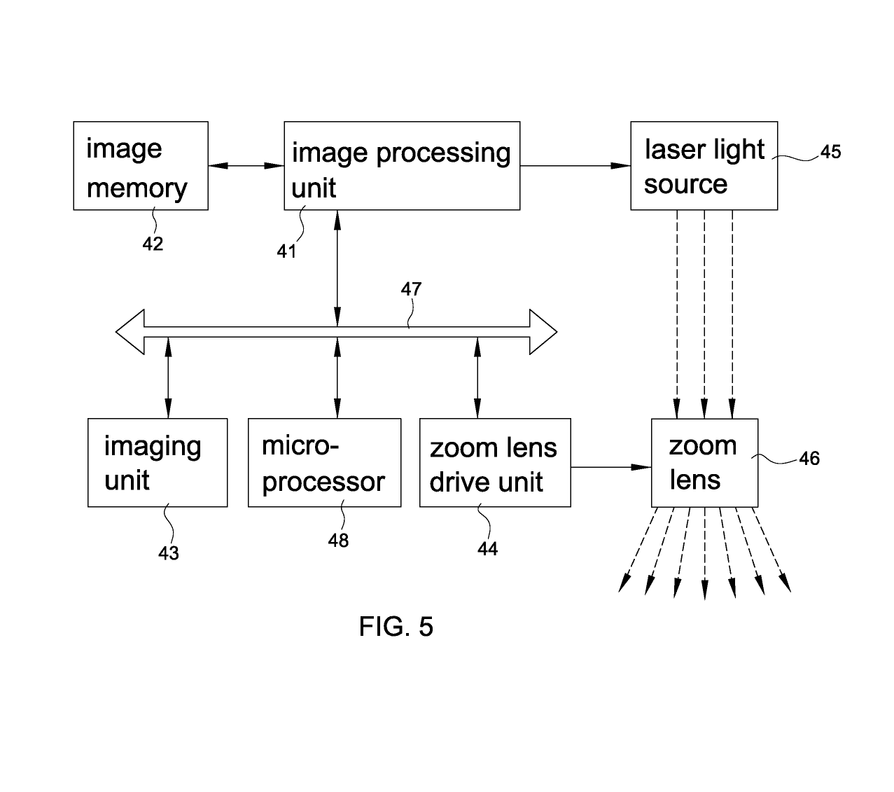

As shown in FIG. 5, the pico-projector 4 comprises an image processing unit 41, an image memory 42 for storing images from the image processing unit 41 and sending images to the image processing unit 41 as instructed, an imaging unit 43, a zoom lens drive unit 44, a laser light source 45 for emitting laser light as instructed by the image processing unit 41, a zoom lens 46 for projecting laser light from the laser light source 45 as instructed by the zoom lens drive unit 44, a bus 47 electrically connected to the image processing unit 41, the imaging unit 43, and the zoom lens drive unit 44, and a microprocessor 48 electrically connected to the bus 47 for controlling the image processing unit 41, the imaging unit 43, and the zoom lens drive unit 44. It is envisaged that laser based light source of the pico-projector 4 can render a high projection quality (i.e., excellent image quality) without focusing. Also, both energy efficiency and brightness is high.

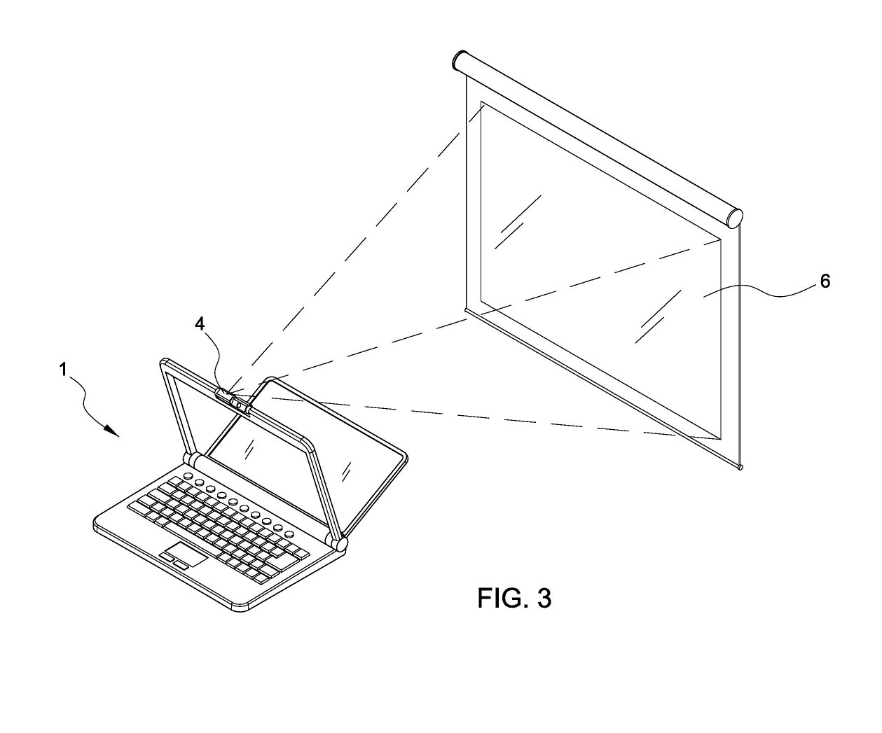

The microprocessor 48 is controlled by the notebook computer 1. In operation, a user may operate the notebook computer 1 to activate the microprocessor 48. And in turn, the microprocessor 48 instructs the image processing unit 41 to fetch images from the image memory 42. Also, the image processing unit 41 instructs the imaging unit 43 to form images and the laser light source 45 to emit laser. The zoom lens drive unit 44 is instructed by the microprocessor 48 to activate the zoom lens 46 which in turn projects images on a screen 6 on a wall (see FIG. 3). It is noted that the pico-projector 4 is pivotal so that it is capable of adjusting the projection angle for providing a quality projection image.

In another embodiment of the pico-projector 4, DLP is implemented. DLP technology is developed by Texas Instruments. DLP has many applications including projectors, pico-projectors, and rear-projection televisions, etc. For a DLP based projector, images are produced by DMDs (Digital Micromirror Devices). DMD is an optical semiconductor on which the DLP projection technology is based. A surface of a DMD chip has several hundred thousand microscopic mirrors arranged in a rectangular array which correspond to the pixels in the image to be displayed. In a DLP projector, the image is created by microscopically small mirrors laid out in a matrix on a semiconductor chip (DMD). Each mirror represents one or more pixels in the projected image. The number of mirrors corresponds to the resolution of the projected image (often half as many mirrors as the advertised resolution due to wobulation). 800×600, 1024×768, 1280×720, and 1920×1080 (HOW) matrices are some common DMD sizes. These mirrors can be repositioned rapidly to reflect light either through the lens or on to a heat sink. Rapidly toggling the mirror between these two orientations (essentially on and off) produces grayscales, controlled by the ratio of on-time to off-time. The mirrors can be individually rotated ±10-12°, to an on or off state. In the on state, light from the projector bulb is reflected into the lens making the pixel appear bright on the screen. In the off state, the light is directed elsewhere (usually onto a heatsink), making the pixel appear dark.

DLP projectors and DLP rear-projection televisions (TVs) have the following advantageous: Smooth and jitter-free images. Perfect geometry and excellent grayscale linearity achievable. Great contrast. No possibility of screen burn-in. Less “screen-door effect” than with LCD projectors. DLP rear-projection TVs generally have a smaller form factor than comparable CRT (cathode ray tube) projectors. DLP rear-projection TVs are considerably cheaper than LCD or plasma flat-panel displays. The use of a replaceable light source means a potentially longer life than CRTs. The light source is more-easily replaceable than the backlights used with LCDs. Lighter weight than LCD and plasma televisions.

In still another embodiment of the pico-projector 4, LCOS is implemented. LCOS is a “micro-projection” or “micro-display” technology typically applied in projection televisions. It is a reflective technology similar to DLP projectors. However, it uses liquid crystals instead of individual mirrors. By way of comparison, LCD projectors use transmissive LCD chips, allowing light to pass through the liquid crystal. In LCOS, liquid crystals are applied directly to the surface of a silicon chip coated with an aluminized layer, with some type of passivation layer, which is highly reflective. LCOS technology can typically produce higher resolution and higher contrast images than standard liquid crystal display and plasma display technologies, which makes it less expensive to implement in such devices as televisions. PBS (polarization beam splitter) splits the incident beam into two beams of differing polarization. For common PBSs, only one of the two output beams is fully polarized. The other contains a mixture of polarization states. Unlike absorptive polarizers, PBSs do not need to absorb and dissipate the energy of the rejected polarization state, and so they are more suitable for use with high intensity beams such as laser light. True PBSs are also useful where the two polarization components are to be analyzed or used simultaneously.

The digital camera 5 is a compact digital camera and comprises an optical system 51 for taking pictures, an image sensor (e.g., CCD (charge-coupled device) image sensor) 52 for sensing pictures taken by the optical system 51, an ADC (analog to digital converter) 53 for converting analog signals of the taken pictures into digital signals, an image formation unit 56 for transforming the digital signals into images, a ROM (read-only memory) 54 for storing instructions required for operating the digital camera 5, a work memory 55 for temporarily storing images from the image formation unit 56, and a compression-decompression unit 57 for compressing or decompressing images from the image formation unit 56 and the work memory 55. Compressed or decompressed images in the compression-decompression unit 57 can also be sent to the work memory 55 for storage. Moreover, data in the work memory 55 can be sent to the image formation unit 56 for image formation purposes.

The digital camera 5 further comprises a removable memory (e.g., USB (Universal Serial Bus) disk) 59 for storing compressed or decompressed image data, and a microprocessor 58 electrically connected to the image sensor 52, the ADC 53, the image formation unit 56, the ROM 54, the work memory 55, and the compression-decompression unit 57 for controlling their operations. The microprocessor 58 is also capable of instructing the work memory 55 to send stored image data to an LCD 3 of the notebook computer 1 for display.

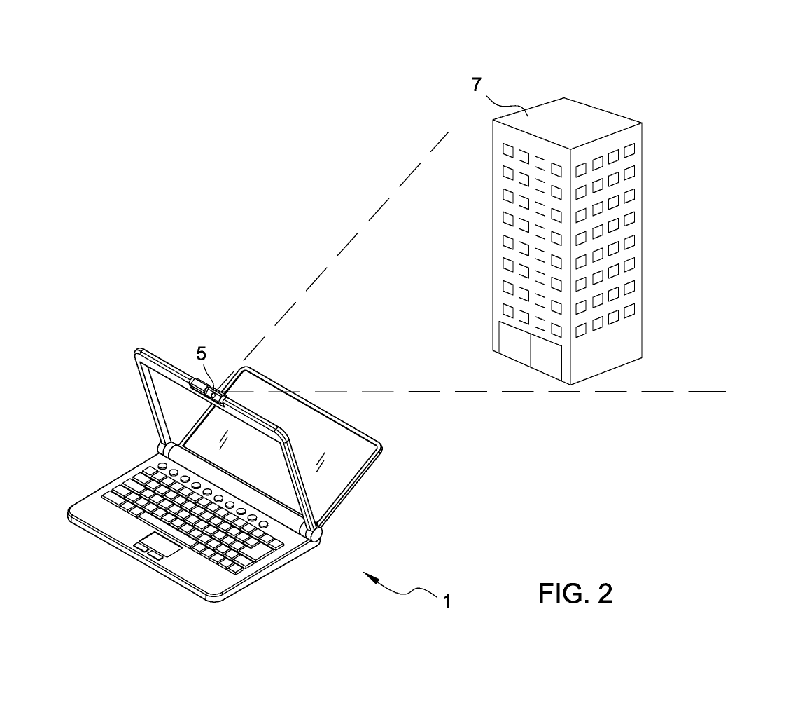

The microprocessor 58 is controlled by the notebook computer 1. In operation, a user may operate the notebook computer 1 to activate the microprocessor 58. And in turn, the microprocessor 58 instructs the optical system 51 to take a picture. For example, as shown in FIG. 2, the digital camera 5 is taking a picture of an object 7. The image sensor 52 senses the taken picture. And in turn, the ADC 53 converts the analog picture into digital signals. Then the image formation unit 56 transforms the digital signals into images. Further, the work memory 55 may temporarily store the images prior to sending same to the LCD 3 of the notebook computer 1 for display. It is noted that the digital camera 5 is pivotal so that it is capable of adjusting its angle for taking a picture of excellent quality.

In short, the notebook computer having both a pico-projector and a digital camera can provide a couple of use choices. Hence, the functions of the notebook computer are greatly enhanced.

While the invention herein disclosed has been described by means of specific embodiments, numerous modifications and variations could be made thereto by those skilled in the art without departing from the scope and spirit of the invention set forth in the claims.

What is claimed is:

1. A notebook computer comprising:
a housing comprising a keyboard;
an LCD (liquid crystal display) pivotably mounted to a front edge of the housing;
an inverted U shaped frame pivotably mounted to the front edge of the housing wherein the frame and the LCD are adapted to rest upon the housing by pivoting;
a pivotal pico-projector on the frame; and
a pivotal digital camera on the frame.

2. The notebook computer of claim 1, wherein the pico-projector comprises an image processing unit, an image memory for storing images from the image processing unit and sending the images to the image processing unit, an imaging unit, a zoom lens drive unit, a laser light source for emitting laser light as instructed by the image processing unit, a zoom lens for projecting laser light from the laser light source as instructed by the zoom lens drive unit, a bus electrically connected to the image processing unit, the imaging unit, and the zoom lens drive unit, and a microprocessor electrically connected to the bus for controlling the image processing unit, the imaging unit, and the zoom lens drive unit.

3. The notebook computer of claim 1, wherein the pico-projector is implemented by DLP (digital light processing) technology with embedded LEDs (light-emitting diodes).

4. The notebook computer of claim 1, wherein the pico-projector is implemented by LCOS (Liquid Crystal on Silicon) technology with embedded LEDs.

5. The notebook computer of claim 1, wherein the pico-projector has a transverse pivot axis having both ends pivotably secured to a horizontal portion of the frame so that the pico-projector is pivotal to adjust its projection angle.

6. The notebook computer of claim 1, wherein the digital camera comprises an optical system for taking pictures, an image sensor for sensing pictures taken by the optical system, an ADC (analog to digital converter) for converting analog signals of the taken pictures into digital signals, an image formation unit for transforming the digital signals into images, a ROM (read-only memory) for storing instructions required for operating the digital camera, a work memory for temporarily storing the images from the image formation unit, and a microprocessor electrically connected to the image sensor, the ADC, the image formation unit, the ROM, and the work memory for controlling their operations, the microprocessor being adapted to instruct the work memory to send the stored images to the LCD of the notebook computer for display.

7. The notebook computer of claim 6, further comprising a compression-decompression unit for compressing or decompressing the images sent from the image formation unit and the work memory, and a removable memory for storing the compressed or decompressed images.

8. The notebook computer of claim 1, wherein the digital camera has a transverse pivot axis having both ends pivotably secured to a horizontal portion of the frame so that the digital camera is pivotal to adjust its picture taking angle.
